(19) United States
(12) Patent Application Publication
(10) Pub. No.: US 2026/0016820 A1
(43) Pub. Date: Jan. 15, 2026

(54) SYSTEMS AND METHODS FOR DETECTING GESTURES OUTSIDE A VEHICLE AND COMPLETING AN ACTION

(71) Applicant: Toyota Jidosha Kabushiki Kaisha, Toyota-shi Aichi-ken (JP)

(72) Inventors: Alexander Charles Granieri, Mountain View, CA (US); Vincent Sarcia Pascual, Dublin, CA (US)

(21) Appl. No.: 18/768,325

(22) Filed: Jul. 10, 2024

(51) Int. Cl. G05D 1/222; B60W 30/06; B60W 30/08

(52) U.S. Cl. CPC G05D 1/222; B60W 30/06; B60W 30/08; B60W 2555/20

(57) ABSTRACT

Systems, methods, and other embodiments described herein relate to predicting an obstacle to completing a task from a detected gesture outside a vehicle and completing the task upon satisfying a corrective response. In one embodiment, a method includes detecting a gesture command for an action from a user outside of a vehicle using sensor data. The method also includes predicting an obstacle for an incomplete task of the action from a vehicle state using the sensor data and notifying the user. The method also includes executing the incomplete task for the action upon a corrective response to the obstacle satisfying a parameter.

### TECHNICAL FIELD

The subject matter described herein relates, in general, to detecting gestures by a vehicle for an action, and, more particularly, to predicting an obstacle to completing a task from a detected gesture outside the vehicle.

### BACKGROUND

Vehicles may be equipped with sensors that facilitate perceiving other vehicles, obstacles, pedestrians, and additional aspects of a surrounding environment. For example, a vehicle may be equipped with a light detection and ranging (LIDAR) sensor that uses light to scan the surrounding environment, while logic associated with the LIDAR analyzes acquired data to detect object presence and other features of the surrounding environment. In further examples, additional/alternative sensors such as cameras may be implemented to acquire information about the surrounding environment from which a system derives awareness about aspects of the surrounding environment. This sensor data can be useful in various circumstances for improving perceptions of the surrounding environment so that systems such as automated driving systems can perceive the noted aspects and accurately plan and navigate a path.

In various implementations, vehicles use sensor data to enhance and personalize convenience features associated with access and comfort. For example, vehicle systems use data from proximity sensors with parking assistance by alerting drivers. Data from ambient light sensors adjust interior lighting automatically based on external conditions that enhance comfort. Vehicle access and interior settings (e.g., seat positions) can vary according to remote data. Still, these vehicle systems lack simpler interactions with the vehicle that include factoring context that is enhanced, thereby diminishing system satisfaction.

### SUMMARY

In one embodiment, example systems and methods relate to predicting an obstacle to completing a task from a detected gesture outside a vehicle and completing the task upon satisfying a corrective response. In various implementations, vehicle systems detect commands from operators and passengers that control access, convenience, etc., systems. For example, an access system detects a unique code for a vehicle operator transmitted using radio frequency from a key fob. The access system retrieves settings for the vehicle operator and unlocks an operator door while keeping other doors locked. However, the access system unlocks all the doors when detecting a different code from a mobile application controlling the vehicle. Although this customization can increase comfort, vehicle systems are limited by command types and incorporating context that increases intelligence. For instance, a vehicle system automatically opens windows according to operator preferences when receiving a command during heavy rainfall, thereby damaging vehicle flooring. Thus, vehicle systems executing tasks associated with convenience and access can lack capabilities and information that causes damage.

Therefore, in one embodiment, a detection system estimates contextual interactions from a user after exiting a vehicle and finishes an incomplete task for an action associated with a vehicle command upon mitigating an obstacle. For instance, the vehicle command is a gesture command for opening windows by the vehicle among an environment having an increased temperature after the vehicle is parked. Here, the detection system can predict an obstacle for completing the action from sensor data and alert the user about a corrective response. In one approach, the detection system instructs an automated system to execute the corrective response automatically for avoiding the obstacle. For example, the detection system receives a weather forecast for a rain storm as the obstacle and delays opening the windows until the rain storm passes. The detection system can also wait for a command about a corrective response from the user, such as partially opening the windows rather than completely.

Furthermore, in one embodiment, the detection system satisfies a parameter for the corrective response prior to completing the action. The parameter can be a safety area around the vehicle that is clear of obstacles. As such, the vehicle completes the action when the obstacle (e.g., a pedestrian) is beyond the safety area. Accordingly, the detection system effectively completes hindered actions and tasks associated with vehicle commands from outside a vehicle through a corrective response, thereby improving system safety and confidence.

In one embodiment, a detection system that predicts an obstacle to completing a task from a detected gesture outside a vehicle and completes the task upon satisfying a corrective response is disclosed. The detection system includes a memory storing instructions that, when executed by a processor, cause the processor to detect a gesture command for an action from a user outside of a vehicle using sensor data. The instructions also include instructions to predict an obstacle for an incomplete task of the action from a vehicle state using the sensor data and notify the user. The instructions also include instructions to execute the incomplete task for the action upon a corrective response to the obstacle satisfying a parameter.

In one embodiment, a non-transitory computer-readable medium for predicting an obstacle to completing a task from a detected gesture outside a vehicle and completing the task upon satisfying a corrective response and including instructions that when executed by a processor cause the processor to perform one or more functions is disclosed. The instructions include instructions to detect a gesture command for an action from a user outside of a vehicle using sensor data. The instructions also include instructions to predict an obstacle for an incomplete task of the action from a vehicle state using the sensor data and notify the user. The instructions also include instructions to execute the incomplete task for the action upon a corrective response to the obstacle satisfying a parameter.

In one embodiment, a method for predicting an obstacle to completing a task from a detected gesture outside a vehicle and completing the task upon satisfying a corrective response is disclosed. In one embodiment, the method includes detecting a gesture command for an action from a user outside of a vehicle using sensor data. The method also includes predicting an obstacle for an incomplete task of the action from a vehicle state using the sensor data and notifying the user. The method also includes executing the incomplete task for the action upon a corrective response to the obstacle satisfying a parameter.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a detection system that is associated with predicting an obstacle to completing a task from a detected gesture outside a vehicle and completing the task upon satisfying a corrective response.

FIG. 3 illustrates an example of automatically parking and unparking a vehicle safely through detecting an obstacle and completing an action to mitigate the obstacle.

FIG. 4 illustrates one embodiment of a method that is associated with predicting an obstacle for an incomplete task from an action associated with a vehicle state and clearing the obstacle through a corrective response.

### DETAILED DESCRIPTION

Systems, methods, and other embodiments associated with predicting an obstacle to completing a task from a detected gesture outside a vehicle and completing the task with a corrective response that is satisfactory are disclosed herein. In various implementations, systems executing vehicle commands from users outside a vehicle lack understanding and awareness about certain environmental scenarios that diminish confidence. For instance, a user communicates a vehicle command for a vehicle to automatically exit a parking spot. Although a pedestrian can potentially cross a path while exiting the parking spot, the vehicle can lack the intelligence for safely avoiding the pedestrian while following the vehicle command. As such, the vehicle may terminate the action to mitigate a potential collision, thereby reducing user satisfaction and confidence with automated parking.

Therefore, in one embodiment, a detection system assists with controlling a vehicle from outside using a gesture command for an action while mitigating and correcting obstacles (e.g., wall) associated with the action. In particular, the detection system can sense various conditions about a vehicle state (e.g., garage parked) demanding a remedy that ensures safe and secure conditions for completing a task associated with the action (e.g., an access action, a parking action, etc.). In one approach, an automated driving system (ADS) executes a corrective response automatically for avoiding the obstacle as directed by the detection system. For example, the detection system receives a gesture command for parking a vehicle. The ADS pulls-in side-view mirrors while midway within a parking spot upon a perception system identifying limited clearance. In another example, the detection system alerts the user about the obstacle, suggests a corrective response, and waits for another vehicle command before completing the task. In this way, the detection system effectively and safely mitigates barriers to completing an action through either automatic assistance from an ADS and a user command, thereby avoiding aborting the action.

Moreover, in one embodiment, the detection system satisfies a parameter associated with the corrective response to the obstacle before proceeding with an incomplete task associated with the action. For example, a parameter is the detection system instructing an ADS to automatically stop a vehicle entering a parking spot upon detecting an animal crossing using sensor data. Here, the detection system can automatically wait until the animal leaves a safety area (e.g., three feet) around the vehicle using sonar data, camera data, etc., as the corrective response for satisfying the parameter. As such, the detection system completes the action upon the animal leaving the safety area. Accordingly, the detection system predicts an obstacle for completing an action associated with the vehicle using sensor data and satisfies a parameter for a corrective response that adequately overcomes the obstacle, thereby improving the exterior and remote vehicle controls.

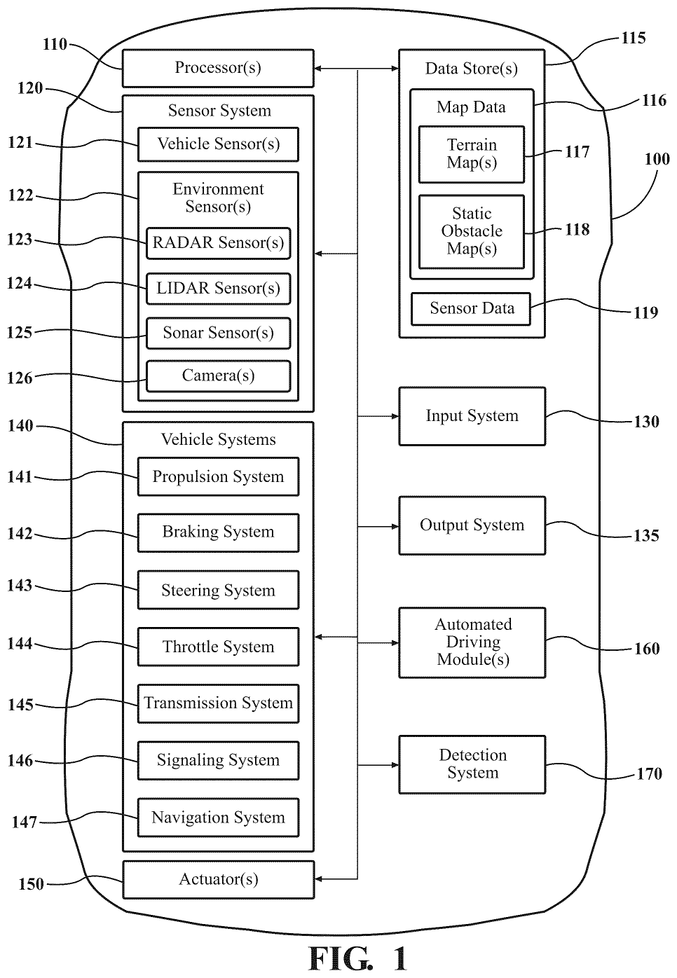

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a detection system 170 uses road-side units (RSU), consumer electronics (CE), mobile devices, robots, drones, and so on that benefit from the functionality discussed herein associated with predicting an obstacle to completing a task from a detected gesture outside a vehicle and completing the task upon satisfying a corrective response.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

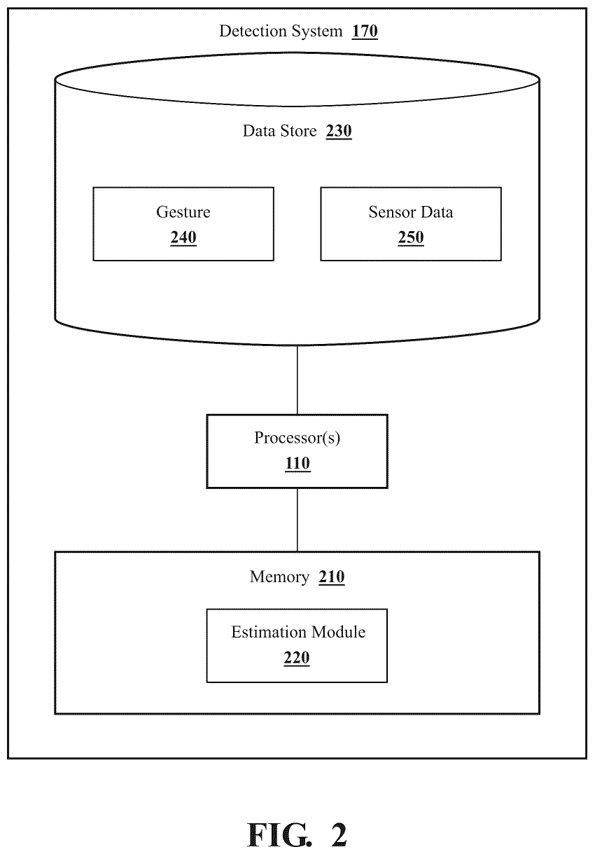

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a detection system 170 that is implemented to perform methods and other functions as disclosed herein relating to predicting an obstacle to completing a task from a detected gesture outside the vehicle 100 and completing the task upon satisfying a corrective response associated with the vehicle 100. The detection system 170, in various embodiments, is implemented partially within the vehicle 100, and as a cloud-based service. For example, in one approach, functionality associated with at least one module of the detection system 170 is implemented within the vehicle 100 while further functionality is implemented within a cloud-based computing system.

With reference to FIG. 2, one embodiment of the detection system 170 of FIG. 1 is further illustrated. The detection system 170 is shown as including a processor(s) 110 from the vehicle 100 of FIG. 1. Accordingly, the processor(s) 110 may be a part of the detection system 170, the detection system 170 may include a separate processor from the processor(s) 110 of the vehicle 100, or the detection system 170 may access the processor(s) 110 through a data bus or another communication path. In one embodiment, the detection system 170 includes a memory 210 that stores an estimation module 220. The memory 210 is a random-access memory (RAM), a read-only memory (ROM), a hard-disk drive, a flash memory, or other suitable memory for storing the estimation module 220. The estimation module 220, for example, includes computer-readable instructions that when executed by the processor(s) 110 cause the processor(s) 110 to perform the various functions disclosed herein.

The detection system 170 as illustrated in FIG. 2 is generally an abstracted form of the detection system 170. Furthermore, the detection system 170 and the estimation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the detection system 170 and/or the estimation module 220, in one embodiment, acquire sensor data 250 that includes at least camera images. In further arrangements, the detection system 170 and/or the estimation module 220 acquire the sensor data 250 from further sensors such as radar sensors 123, LIDAR sensors 124, and other sensors as may be suitable for identifying vehicles and locations of the vehicles.

Accordingly, the detection system 170 and/or the estimation module 220, in one embodiment, control the respective sensors to provide the data inputs in the form of the sensor data 250. Additionally, while the detection system 170 and/or the estimation module 220 are discussed as controlling the various sensors to provide the sensor data 250, in one or more embodiments, the detection system 170 and/or the estimation module 220 can employ other techniques to acquire the sensor data 250 that are either active or passive. For example, the detection system 170 passively sniff the sensor data 250 from a stream of electronic information provided by the various sensors to further components within the vehicle 100. Moreover, the estimation module 220 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. Moreover, the detection system 170, in one embodiment, controls the sensors to acquire the sensor data 250 about an area that encompasses 360 degrees about the vehicle 100 in order to provide a comprehensive assessment of the surrounding environment. Of course, in alternative embodiments, the detection system 170 may acquire the sensor data 250 about a forward direction alone when, for example, the vehicle 100 is not equipped with further sensors to include additional regions about the vehicle and/or the additional regions are not scanned due to other reasons.

Moreover, in one embodiment, the detection system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the estimation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes gesture 240 that is a vehicle command detected from a body movement(s) of a user. For instance, the vehicle command is associated with one of parking and unparking the vehicle 100 using a hand motion for beckoning as the gesture 240. An access action to unlock a vehicle door signal with a sideway hand motion can be another gesture. Furthermore, as explained below, the detection system 170 can implement a learning model that infers the gesture 240 using data from one or more camera(s) 126, an infrared (IR) camera, one or more LIDAR sensors 124, a range estimator, etc.

In one approach, the learning model uses a machine learning algorithm embedded within the detection system 170, such as a convolutional neural network (CNN), to perform semantic segmentation over the sensor data 250 from which further information is derived. Of course, in further aspects, the detection system 170 may employ different machine learning algorithms or implement different approaches for performing the associated functions, which can include deep convolutional encoder-decoder architectures, or another suitable approach that generates semantic labels for the separate object classes represented in the image. Whichever particular approach the detection system 170 implements, the learning model can output semantic labels identifying objects represented in the sensor data 250, including gesture commands.

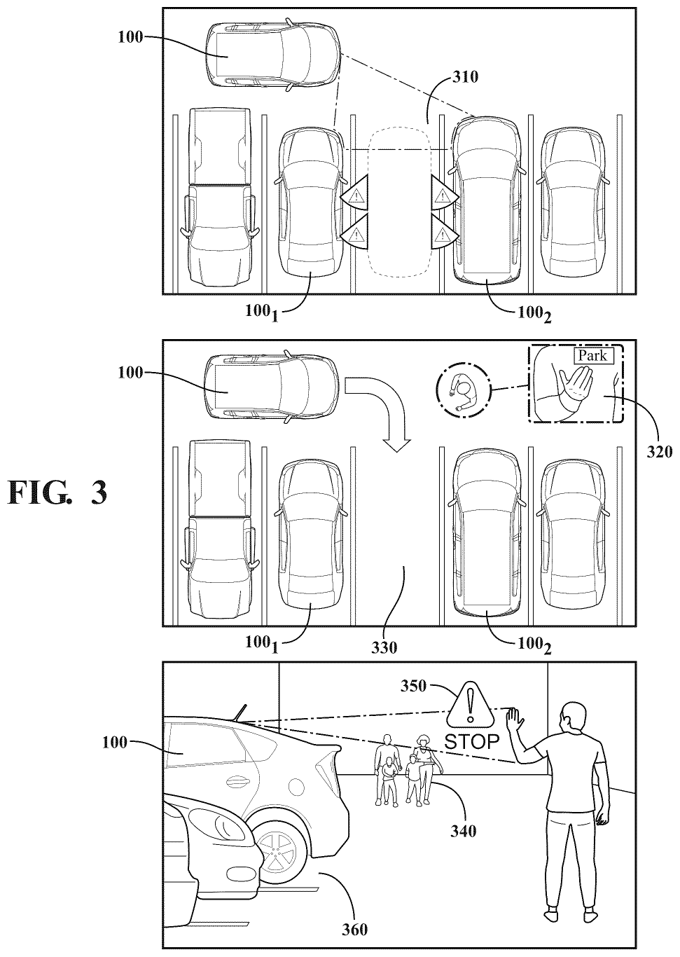

Turning now to FIG. 3, an example of automatically parking and unparking the vehicle 100 safely through detecting an obstacle and completing an action to mitigate the obstacle is illustrated. Although the example involves parking the vehicle 100, the detection system 170 can detect any obstacle to completing an action and mitigate the obstacle automatically using an automated driving module(s) 160, requesting user assistance, etc. The detection system 170, in one embodiment, is further configured to perform additional tasks beyond controlling the respective sensors to acquire and provide the sensor data 250. For example, the detection system 170 includes instructions that cause the processor 110 to detect a gesture command for an action from a user outside of the vehicle 100 using the sensor data 250. The estimation module 220 can predict an obstacle for an incomplete task of the action from a vehicle state using the sensor data 250 and notify the user. For instance, the detection system 170 perceives the vehicle state as one of an open window, objects left in the vehicle 100, a person occupying the vehicle 100, an operator walking away from the vehicle 100, and an authorized person outside the vehicle 100. Furthermore, in one approach, the detection system 170 executes the incomplete task for the action upon a corrective response to the obstacle satisfying a parameter, such as a change from the vehicle state.

Regarding details about detecting the gesture command, the detection system 170 can implement a vision model for perception (e.g., Toyota Sense) and identify the gesture command using the sensor data 250. In one approach, the vision model is a learning model that is data-driven and trained. Here, the vision model trains to recognize user-specific body gestures using a head, hand, foot, arm, leg, etc., motion. For instance, the learning model trains with data about the user and the vehicle state. As such, the learning model can infer a feature of the gesture command using the sensor data 250 during implementation with increased accuracy. In one approach, the gesture command is contextually related to a vehicle state while the user is outside from the vehicle 100. For example, an upward gesture rolls up windows of the vehicle 100 upon the user exiting. A cutting and slashing gesture through a hand motion turns off a system (e.g., lights) of the vehicle 100 when the user is outside. However, the cutting and slashing action can be ignored within the cabin. A keying motion (e.g., a wrist twist and push) can open a trunk, lock doors, etc., of the vehicle 100. As added security, the detection system 170 may authenticate a user prior to accepting the gesture command. Authentication can involve detecting a token from a key fob, two-factor verification through a mobile application, facial recognition using data from the one or more camera(s) 126, etc.

The estimation module 220 can predict an obstacle for an incomplete task of the action from a vehicle state using the sensor data 250 as follows. In one approach, the obstacle for a vehicle state is one of a wall and a person entering a boundary area around the vehicle 100 and represents a hazard associated with a parking action. Detecting these and other obstacles can involve a perception model using sonar data, ultrasonic data, etc., from the sensor data 250, such as a vision model that is trained with driving scenery. An obstacle and another vehicle state can involve safety during an access action where an object is near one of a door and a tailgate associated with the vehicle 100. Other examples of an obstacle related to the vehicle state can include an open window, objects (e.g., an animal) left in the vehicle 100, a person occupying the vehicle 100, an operator walking away from the vehicle 100, an authorized person outside the vehicle 100, a weather forecast, local crime, etc., that impact safety and exhibit various contexts.

Furthermore, in another embodiment, the estimation module 220 identifies an object (e.g., a valuable good) left on a seat and a window remaining rolled down when the user exits the vehicle 100 as an obstacle derived from the vehicle state. As such, the detection system 170 pauses and leaves an action with an incomplete task upon identifying an obstacle. In this way, the detection system 170 avoids safety hazards and factors context associated with vehicle states.

In FIG. 3, the detection system 170 identifies a gesture command to automatically park from outside the vehicle 100. The estimation module 220 can predict that the parking spot 310 has a limited clearance using the sensor data 250 and a global positioning device (GPS) data from navigation system 147 while the vehicle 100 attempts to automatically park using the automated driving module(s) 160. The limited clearance can be due to vehicles 1001 and 1002 parking close to parking boundaries that the estimation module 220 perceives using the sensor data 250. The limited clearance can harm the vehicle 100 and create discomfort when the user exits from the vehicles 1001 and 1002 obstructing door openings. As such, the detection system 170 can pause the parking action when entering the parking spot 310 with incomplete tasks until the obstacle clears, trigger evasive action, requesting assistance from a user, etc.

Moreover, in one embodiment, the detection system 170 generates an alert for notifying the user about responsive action to the obstacle before executing an incomplete task. The alert can indicate responsive action automatically upcoming by the vehicle 100. A responsive action by the user associated with executing an incomplete task can also be triggered by the alert. In one approach, the alert is one of flashing headlights, honking, a verbal alarm, an audible alarm, a signal for a wireless device of the user, and a picture for the wireless device. Furthermore, the alert can be contextually generated with locality derived from GPS information and knowledge about local conditions, such as crime, weather, etc. For example, the detection system 170 notifies the user about an area prone to crime upon receiving a gesture command outside of the vehicle 100 for leaving windows open during summertime and perceiving valuable objects within the vehicle 100. In this way, the alert notifies the user about responsive action and context associated with the obstacle, thereby improving user interaction and situational awareness.

Details about the detection system 170 executing the incomplete task for the action upon a corrective response to the obstacle satisfying a parameter can involve the following. For the parking spot 310, the detection system 170 can pause automatic parking that is in progress and delay incomplete tasks for the automatic parking until the vehicle state changes. For instance, the detection system 170 anticipates that the vehicle 1002 will leave shortly from detecting a brake light using the sensor data 250 that alleviates a safety hazard associated with limited clearance for the parking spot 310 and waits a predetermined time. In one approach, the detection system 170 performs a default action when a time period expires without receiving a corrective response from the automated driving module(s) 160, the user, etc.

In another example, the detection system 170 identifies a beckoning gesture 320 to automatically park the vehicle 100 in the parking spot 330 between the other vehicles 1001 and 1002. The estimation module 220 predicts an obstacle as side-mirrors of other vehicles 1001 and 1002 with a learning model when turning into the parking spot 330 using the sensor data 250 (e.g., an image). The detection system 170 can automatically avert aborting the automatic parking and avoid delays by automatically folding side-view mirrors of the vehicle 100 without pausing the turn. This can be a corrective response satisfying a parameter when folding the side-view mirrors allows adequate clearance around a safety area (e.g., four feet) around the vehicle 100 that avoids a collision with the other vehicles 1001 and 1002. The adequate clearance also allows an occupant to comfortably exit the vehicle 100.

Moreover, the detection system 170 can also avert aborting the automatic parking by stopping the vehicle 100 using vehicle commands from the automated driving module(s) 160 and estimating a different path for entering the parking spot 330 as a corrective response. If the different path does not satisfy the parameter for safety, the detection system 170 can search for another parking spot as a corrective response using the sensor data 250.

In various implementations, the detection system 170 executes an incomplete task for an action through navigating the vehicle 100 currently within a parking area associated with an unparking gesture. For instance, the estimation module 220 predicts an obstacle as pedestrians 340 approaching within a safety area of the vehicle 100 exiting the parking spot 360. The automated driving module(s) 160 can momentarily halt backing-out by the vehicle 100 and alert the user. Here, the corrective response can be a hand gesture 350 that is a vehicle command to wait a predetermined time until the obstacle clears. For example, the pedestrians 340 being beyond a certain distance from the safety area (e.g., 15 feet) satisfies a parameter. The corrective response can also involve receiving additional vehicle commands from the automated driving module(s) 160 when satisfying the parameter is very unlikely, such as nudging the vehicle 100 slightly into the parking spot 360.

An incomplete task can also be associated with an access action for the vehicle 100. For instance, the user commands the vehicle 100 using a hand gesture and voice command that is authenticated by the detection system 170 with the learning model to automatically open an operator door. Here, the vehicle state is parked and the estimation module 220 predicts an obstacle as the vehicle 1001 using the sensor data 250. For example, the vehicle 1001 is within a safety area surrounding the front, sides, back, etc., from the vehicle 100. A corrective response can be for the detection system 170 to wait until the vehicle 1001 leaves an adjacent parking spot before completing the access action. Another corrective response is automatically pulling the vehicle 100 out from the parking spot until satisfying the safety area for opening the operator door. Thus, the detection system 170 intelligently predicts an obstacle to a gesture command for an action and selects a corrective response for completing the action that avoids injury.

In one approach, the obstacle is physical injury and theft associated with a detected vehicle command for a convenience action. For instance, the gesture command is a slash-up for closing a window from a user while leaving the vehicle 100. Here, the estimation module 220 detects that an animal (e.g., dog), a child, etc., is left behind in the vehicle 100 using the sensor data 250. As such, the detection system 170 pauses the convenience action and alerts the user for a corrective response accordingly. For example, the corrective response is the user removing the animal, child, etc., from the vehicle 100 that satisfies a safety parameter. The detection system 170 then executes the incomplete task for the convenience action.

Similarly, a slash down for rolling-down a window from the user while leaving the vehicle 100 can be an obstacle when leaving a valuable object within a parked area. This action is particularly problematic when vehicle 100 is located within an area that is crime-prone. Correspondingly, a corrective response is rolling-up the windows, locking doors, and/or activating a security system for the vehicle 100. Furthermore, activating the security system may involve avoiding beeping confirmation to avoid noise pollution, disturbing neighbors, etc.

Another example of an obstacle predicted by the estimation module 220 is environmental harm in the future for a convenience action. For example, the gesture command is a sideways slash for leaving open a sunroof and windows from a user while leaving the vehicle 100 when ambient temperatures are elevated. Here, the estimation module 220 infers inclement weather from forecasts about the area using GPS information and the sensor data 250. For instance, rain can damage seats, flooring, electrical components, etc., within the cabin of the vehicle 100. The corrective response can be opening the sunroof of the vehicle 100 upon the inclement weather succumbing, weather forecasts changing, etc. Accordingly, the detection system 170 mitigates environmental harm and physical injury associated with a vehicle command from a user outside the vehicle 100 while effectively and intelligently completing the vehicle action.

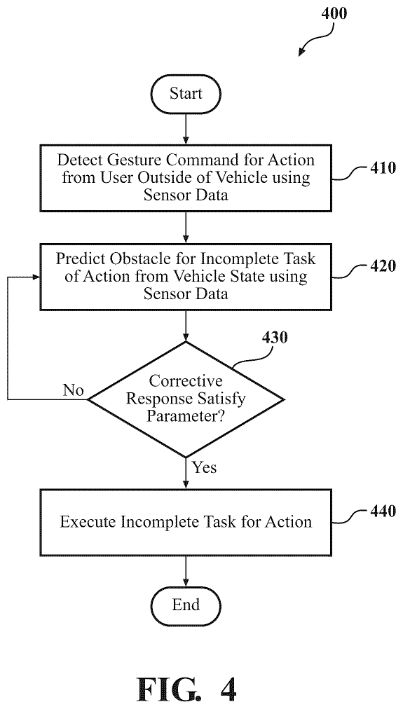

Concerning FIG. 4, one embodiment of a method 400 that is associated with predicting an obstacle for an incomplete task from an action associated with a vehicle state and clearing the obstacle through a corrective response is illustrated. The method 400 will be discussed from the perspective of the detection system 170 of FIGS. 1 and 2. While the method 400 is discussed in combination with the detection system 170, it should be appreciated that the method 400 is not limited to being implemented within the detection system 170 but is instead one example of a system that may implement the method 400.

At 410, the detection system 170 detects a gesture command for an action (e.g., an access action, a parking action, etc.) from a user outside of the vehicle 100 using the sensor data 250. A vision model for perception (e.g., Toyota Sense) detects features from the sensor data 250 (e.g., an image) to derive the gesture command. As previously explained, the vision model can be a learning model that is data-driven and trained to recognize motion from body gestures for a particular user, thereby increasing accuracy. For instance, the learning model trains with data about the user during a particular vehicle state (e.g., entering a parking spot, exiting a parking spot, etc.). Although this example discusses a gesture command, the detection system 170 can perceive other vehicle commands for the action.

Moreover, in one approach, the gesture command forms a nexus with a vehicle state while the user is outside from the vehicle 100. For instance, a cutting and slashing gesture through a hand motion turns off a system (e.g., lights) of the vehicle 100 when the user is facing the vehicle 100 and the vehicle 100 is parked outside a garage. However, the hand motion is ignored when the user is detected as walking away from the vehicle 100. Similarly, a keying motion can lock doors of the vehicle 100 when parked and the user is facing a side of the vehicle 100.

At 420, the estimation module 220 predicts an obstacle for an incomplete task of the action from the vehicle state using the sensor data 250. Here, in one embodiment, an obstacle for a vehicle state is one of a wall and a person entering a boundary area around the vehicle 100. The obstacle acts as a hazard associated with a parking action, such as caused by the size of the vehicle 100 and parked positions of adjacent vehicles. As previously explained, the detection system 170 can identify the one of a wall and a person using sonar data, ultrasonic data, etc., from the sensor data 250 and a perception model.

Furthermore, an obstacle can exist for an access action where an object is near one of a door, a tailgate, etc., associated with the vehicle 100 and represents another vehicle state. Other examples of an obstacle related to the vehicle state can include an open window, objects (e.g., an animal) left behind, a person occupying the vehicle 100, an operator walking away from the vehicle 100, an authorized person outside the vehicle 100, etc., that impact safety. Obstacles also include a weather forecast, local crime, etc., that present context for intelligently and insightfully executing the action.

In one embodiment, the detection system 170 generates an alert for notifying the user about responsive action to the obstacle automatically upcoming by the vehicle 100, requesting a responsive action by the user, etc. The alert can be one of flashing headlights, honking, a verbal alarm, an audible alarm, a signal for a wireless device of the user, and a picture for the wireless device. As previously explained, the alert can be contextually generated with locality derived from GPS information and knowledge about local conditions, such as crime, weather, etc. As such, the alert notifies the user about responsive action and context associated with the obstacle, thereby increasing situational awareness.

At 430, the detection system 170 determines whether a corrective response satisfies a parameter. Here, the parameter can be a safety area, clearance, cabin temperature, etc., associated with the vehicle 100. For an incomplete task involving a parking action by the automated driving module(s) 160, the detection system 170 can pause automatic parking while in progress. The incomplete task for the automatic parking can be suspended until the vehicle state changes. For example, the detection system 170 anticipates that a vehicle parked in an adjacent spot will leave shortly from detecting a brake light using the sensor data 250. The adjacent spot being unoccupied can reduce a safety hazard associated with limited clearance for parking, thereby satisfying a parking parameter. As such, the detection system 170 delays automated parking independent of user input for a predetermined time as a corrective response. The detection system 170 can also perform a default action when a time period expires without receiving the corrective response from the automated driving module(s) 160, the user, etc.

An access action for the vehicle 100 can also encounter an obstacle. Here, a user may command the vehicle 100 using a hand gesture to automatically unlock and open an operator door with an actuator motor while in a parked state. The estimation module 220 predicts an obstacle within a safety area of the vehicle 100 as an approaching bicycle. A corrective response can be for the detection system 170 to automatically wait until the perception system identifies the bicycle passing the operator door before completing the access action. This satisfies the safety area for opening the operator door as a parameter. The user can also communicate a gesture command for the vehicle 100 to notify the bicycle rider about an access action through flashing lights as another corrective response.

At 440, the detection system 170 executes the incomplete task for the action upon satisfying the parameter. For parking actions, the incomplete task can be moving from a half-parked to a full-parked position within a spot. Similarly, the automated driving module(s) 160 can continue pulling the vehicle 100 out from a parking spot after pausing in progress upon detecting a pedestrian within a safety area. As another incomplete task, the vehicle 100 can complete opening a power door using an actuator after unlocking the door due to a potential collision. Otherwise, the estimation module continues to predict the obstacle to the incomplete task until satisfying the parameter with a corrective response. Therefore, the detection system 170 completes actions associated with vehicle and gesture commands from outside a vehicle through having a corrective response meet an operational parameter, thereby improving system intelligence and safety.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), the GPS, the navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or the navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the detection system 170, and/or an automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the detection system 170, and/or the automated driving module(s) 160 may control some or all of the vehicle systems 140 and, thus, may be partially or fully autonomous as defined by the society of automotive engineers (SAE) levels 0 to 5.

The processor(s) 110, the detection system 170, and/or the automated driving module(s) 160 can be operatively connected to communicate with the various vehicle systems 140 and/or individual components thereof. For example, the processor(s) 110, the detection system 170, and/or the automated driving module(s) 160 can be in communication to send and/or receive information from the various vehicle systems 140 to control the movement of the vehicle 100. The processor(s) 110, the detection system 170, and/or the automated driving module(s) 160 may control some or all of the vehicle systems 140.

The processor(s) 110, the detection system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the detection system 170, and/or the automated driving module(s) 160 can control the direction and/or speed of the vehicle 100. The processor(s) 110, the detection system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the detection system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A detection system comprising:
a memory storing instructions that, when executed by a processor, cause the processor to:
detect a gesture command for an action from a user outside of a vehicle using sensor data;
predict an obstacle for an incomplete task of the action from a vehicle state using the sensor data and notify the user; and
upon a corrective response to the obstacle satisfying a parameter, execute the incomplete task for the action.

2. The detection system of claim 1, wherein the instructions for the corrective response to the obstacle satisfying the parameter further include instructions to:
move by the vehicle automatically one of a stopped position, a door position, and a mirror position associated with the vehicle that avoids the obstacle, the parameter is a safety area around the vehicle.

3. The detection system of claim 2, wherein the instructions to execute the incomplete task for the action further include instructions to:
navigate the vehicle within a parking area using commands from an automated driving system (ADS), wherein the gesture command is associated with one of parking and unparking the vehicle.

4. The detection system of claim 1, wherein the instructions for the corrective response to the obstacle satisfying the parameter further include instructions to:
delay the incomplete task until the vehicle state changes, wherein the vehicle state is anticipated.

5. The detection system of claim 1, wherein the instructions to notify the user further include instructions to:
generate an alert associated with the obstacle, the alert is one of flashing headlights, honking, a verbal alarm, a signal for a wireless device of the user, and a picture for the wireless device.

6. The detection system of claim 5, wherein the instructions for the corrective response to the obstacle satisfying the parameter further include instructions to:
receive a vehicle command from the user according to the vehicle state and the alert, the vehicle command is different than the gesture command.

7. The detection system of claim 1, wherein the instructions to detect the gesture command for the action further include instructions to:
infer by a learning model a feature of the gesture command using the sensor data, the learning model is trained with data about the user and the vehicle state.

8. The detection system of claim 1, wherein:
the obstacle is a one of a wall and a person within a boundary area around the vehicle; and
the obstacle is proximate to one of a door and a tailgate associated with the vehicle.

9. The detection system of claim 1, wherein the vehicle state is one of an open window, objects left in the vehicle, a person occupying the vehicle, an operator walking away from the vehicle, an authorized person outside the vehicle, and a weather forecast, and the parameter factors a change from the vehicle state.

10. A non-transitory computer-readable medium comprising:
instructions that when executed by a processor cause the processor to:
detect a gesture command for an action from a user outside of a vehicle using sensor data;
predict an obstacle for an incomplete task of the action from a vehicle state using the sensor data and notify the user; and
upon a corrective response to the obstacle satisfying a parameter, execute the incomplete task for the action.

11. The non-transitory computer-readable medium of claim 10, wherein the instructions for the corrective response to the obstacle satisfying the parameter further include instructions to:
move by the vehicle automatically one of a stopped position, a door position, and a mirror position associated with the vehicle that avoids the obstacle, the parameter is a safety area around the vehicle.

12. A method comprising:
detecting a gesture command for an action from a user outside of a vehicle using sensor data;
predicting an obstacle for an incomplete task of the action from a vehicle state using the sensor data and notifying the user; and
upon a corrective response to the obstacle satisfying a parameter, executing the incomplete task for the action.

13. The method of claim 12, wherein the corrective response to the obstacle satisfying the parameter further includes:
moving by the vehicle automatically one of a stopped position, a door position, and a mirror position associated with the vehicle that avoids the obstacle, the parameter is a safety area around the vehicle.

14. The method of claim 13, wherein executing the incomplete task for the action further includes:
navigating the vehicle within a parking area using commands from an automated driving system (ADS), wherein the gesture command is associated with one of parking and unparking the vehicle.

15. The method of claim 12, wherein the corrective response to the obstacle satisfying the parameter further includes:
delaying the incomplete task until the vehicle state changes, wherein the vehicle state is anticipated.

16. The method of claim 12, wherein notifying the user further includes:
generating an alert associated with the obstacle, the alert is one of flashing headlights, honking, a verbal alarm, a signal for a wireless device of the user, and a picture for the wireless device.

17. The method of claim 16, wherein the corrective response to the obstacle satisfying the parameter further includes:
receiving a vehicle command from the user according to the vehicle state and the alert, the vehicle command is different than the gesture command.

18. The method of claim 12, wherein detecting the gesture command for the action further includes:
inferring by a learning model a feature of the gesture command using the sensor data, the learning model is trained with data about the user and the vehicle state.

19. The method of claim 12, wherein:
the obstacle is a one of a wall and a person within a boundary area around the vehicle; and
the obstacle is proximate to one of a door and a tailgate associated with the vehicle.

20. The method of claim 12, wherein the vehicle state is one of an open window, objects left in the vehicle, a person occupying the vehicle, an operator walking away from the vehicle, and a weather forecast, and the parameter factors a change from the vehicle state.
